(19) United States
(12) Patent Application Publication
(10) Pub. No.: US 2009/0089070 A1
(43) Pub. Date: Apr. 2, 2009

(54) System and Method for Validating and Processing Customer Entered Addresses

(75) Inventors: Dean Engel, Littleton, CO (US); Phil Benz, Denver, CO (US); Sudhir Pondugula, Cumming, GA (US); Susan Pruett, Englewood, CO (US); Chad Hartman, Erie, CO (US)

Correspondence Address: HENSLEY KIM & HOLZER, LLC, 1660 LINCOLN STREET, SUITE 3000, DENVER, CO, 80264, US

(73) Assignee: LEVEL 3 COMMUNICATIONS, LLC, Broomfield, CO (US)

(21) Appl. No.: 11/865,593

(22) Filed: Oct. 1, 2007

(51) Int. Cl. G06F 17/30

(52) U.S. Cl. 705/1

(57) ABSTRACT

A system includes an address validation and resolution module operable to determine a location corresponding to a civic address; a location key generator operable to generate a location key adapted to index a set of location-based services identifiers; and an available services determination module operable to use the location key to index the set of location-based services identifiers to determine location-based services available at the civic address. An embodiment of a computer-implemented method includes receiving address data identifying a civic address associated with a, determining a location corresponding to the identified civic address based on the address data; and determining whether one or more services are available at the identified civic address based on the determined location.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2006 Level 3 Communications, LLC.

### TECHNICAL FIELD

Embodiments of the present invention generally relate to validating customer-entered addresses. More specifically, embodiments relate to providing location-based services based on customer-entered addresses.

### BACKGROUND

In the field of telecommunications the address of the subscriber is used for numerous purposes. Telecommunications service providers must be able to identify the subscriber and his/her location in order to provide or facilitate effective service. Effective subscriber management is relevant to numerous services, such as 911 emergency dispatching, local number portability, taxes and service provisioning. The MSAG address format is used in the Automatic Location Identification (ALI) database used for Enhanced 911 (E-911). In the Plain Old Telephone Service (POTS) environment Local Exchange Carriers (LECs) provide service to local areas (e.g., LATAs). Because of the local presence, subscriber addresses are generally known or easily obtained by LECs in a standard, consistent format. For example a LEC technician typically obtains the address of a new subscriber when the technician goes to the address to install service, and service technicians can work to correct address errors prior to a customer request.

By contrast, in a Voice over Internet Protocol (VoIP) environment there is typically not a ready association between local areas and the VoIP service provider. Wholesale VoIP service providers operate over wider geographic areas and subscriber bases. In addition, when new VoIP service is added at a location, the address is typically not obtained in advance or able to be validated by, for example, sending a technician to the local site as it might be done in the POTS environment. Generally, the subscriber enters his/her address, for example, through a web site on the Internet. The format of the addresses can be input using any number of different formats and naming conventions. For example, on a given street, one subscriber may enter one street name (e.g., Elm Street) while another subscriber may enter a county highway (e.g., Hwy 42). While both address names may be correct, such diversity of naming conventions and formats can make subscriber identification and management very difficult for VoIP service providers.

### SUMMARY

Embodiments of the present invention generally relate to validating customer-entered addresses. More specifically, embodiments relate to providing location-based services based on customer-entered addresses

An embodiment of a computer-implemented method for providing a location-based service includes receiving address data identifying a civic address associated with a, determining a location corresponding to the identified civic address based on the address data; and determining whether one or more services are available at the identified civic address based on the determined location. The received address data may include a street name and a street number, and determining a location corresponding to the identified address may include determining a first street segment of the named street on one side of the identified address and a second street segment of the named street on another side of the received address. The street number of the first street segment, the street number of the identified address and a street number of the second street segment may identify contiguous sections of the named street.

An embodiment of the method may further include generating a location key based on the location. Generating the location key may involve combining a rate center associated with the identified address and one or more area criteria associated with the identified address. The method may still further involve mapping the location key to a set of one or more location-based service identifiers. The received address data may include at least one name chosen from a variable name space, and the method may further involve translating the at least one name chosen from the variable name space to a corresponding name in a fully qualified name space. The fully qualified name space may include at least a subset of a Master Street Address Guide (MSAG).

An embodiment of the method may still further include validating the received address data to determine if the identified address is an actual address. Validating the received address data may involve searching a customer location data store for the identified address, the customer location data store storing data that associates previously validated addresses with locations, and if the identified address is not found in the customer location data store, querying a geospatial data store for a location corresponding to the identified address, and if the geospatial mapping service does not supply a location corresponding to the identified address, querying a postal service data store to indicate whether the identified address is an actual address; and if the postal service data store does not indicate whether the identified address is an actual address, determining a probability that the identified address is an actual address and accepting the identified address based on a confidence factor. Determining a location corresponding to the identified address may further include, if the postal service indicates that the identified address is an actual address, querying the geospatial mapping service with one or more area criterion to obtain a determined location and accepting the address based on the confidence factors.

An embodiment of a system for identifying one or more location-based services available at an address, includes an address validation and resolution module operable to determine a location corresponding to a civic address; a location key generator operable to generate a location key adapted to index a set of location-based services identifiers; and an available services determination module operable to use the location key to index the set of location-based services identifiers to determine location-based services available at the civic address. The address validation and resolution module may further be operable to validate the civic address by querying one or more customer supplied data stores, a geospatial data store and a postal service. The location key generator may generate the location key by combining rate center data with one or more area criteria. The system may further include a Master Street Address Guide (MSAG) address resolution module operable to resolve the civic address to an MSAG address. The system may still further include an MSAG resolution rule set comprising rules for deriving alternative spellings of names in the civic address. The MSAG resolution rule set may include one or more of city name rules, street name rules, and phonetic rules.

An embodiment of a computer-readable medium has computer-executable instructions that cause a computer to carry out a process. The process may include steps of receiving a civic address including a plurality of names selected from a variable namespace, searching an address reference set for a name included in the civic address, and if the name is not found in the address reference set, deriving an alternative spelling of the name; and searching the address reference set with the alternative spelling of the name. Deriving an alternative spelling may involve phonetically mapping the name to an alternative spelling of the name. Deriving an alternative spelling may involve mapping the name to a spelling that is used in a namespace of the address reference set.

### BRIEF DESCRIPTION OF THE DRAWINGS

FIG. 1 illustrates an exemplary operating environment in which address resolution and processing can be carried out in accordance with various embodiments.

FIG. 2 illustrates an exemplary subscriber processing system in accordance with the embodiment of FIG. 1.

FIG. 3 illustrates an E-911 provisioning system in accordance with the embodiment of FIG. 1.

FIG. 4 is a flowchart illustrating an address validation and services determination algorithm in accordance with one embodiment.

FIG. 5 is a flowchart illustrating an address validation algorithm in accordance with the embodiment of FIG. 4.

FIG. 6 is a flowchart illustrating a location estimation algorithm in accordance with the embodiment of FIG. 4.

FIG. 7 is a flowchart illustrating a rule-based MSAG address resolution algorithm in accordance with one embodiment.

FIG. 8 illustrates and exemplary portion of a street, illustrating segments of the street in different locations;

FIG. 9 illustrates a general purpose computing system that can be used to implement one or more embodiments of the systems, methods and computer-readable media described herein.

While the invention is amenable to various modifications and alternative forms, specific embodiments have been shown by way of example in the drawings and are described in detail below. The intention, however, is not to limit the invention to the particular embodiments described.

### DETAILED DESCRIPTION

Embodiments of the present invention generally relate to providing location-based services. More specifically, embodiments relate to systems and methods for validating and processing customer entered addresses.

In some telecommunications environments the telecommunication service provider has a wide geographic presence (e.g., country wide). In these and other situations, the telecommunication service provider may not have a complete list of addresses in all localities spanned by the telecommunication service provider. For example, in the field of VoIP telecommunication service, communication service is provided over geographically distributed networks, including the Internet. In the VoIP environment, VoIP service providers typically receive address information from customers (e.g., subscribers, tier 2 or tier 3 network service provider customers, etc.) who enter their addresses “online” (i.e., through a computer connected to the Internet). Customers may enter their addresses in any number of varying formats and using any number of place names. Such varying formats and place names may not be recognized by the VoIP service provider, may not be in a format (e.g., MSAG) suitable for supporting Telephone provisioning, including E-911 services, and may be completely invalid.

Embodiments of the present relate to systems and methods for validating addresses entered by customers. Embodiments further generate locations corresponding to valid addresses. The locations can be mapped to telecommunication services, if any, that are available at the addresses. A location can be specified in the form of a location key that corresponds to an entry in a telecommunication services data store. In some embodiments, a location key can include a rate center and a geographic designation, such as, but not limited to a county or zip code.

In some embodiments, a customer entered address is validated by searching a customer locations data store that includes one or more addresses and locations associated with the one or more addresses. In some embodiments, if the customer entered address is not found in the customer locations data store, additional data services are queried (including address lists and geospatial data) for a location associated with the customer entered address. Further, in some embodiments, if the data service is unable to provide a location associated with the customer entered address, a postal service data store is queried to determine if the customer entered address is recognized as valid by the postal service.

In various embodiments, the location corresponding to the customer entered address can be provided by the customer locations data store and/or the geospatial data store. If the location is not available through the customer locations data store or the geospatial data store and the postal service data store indicates the customer entered address is valid, a location estimation process is carried out to determine the corresponding location. If the customer entered address is recognized as valid by the postal service, an location estimation process is carried out wherein one or more street segments on either or both sides of the customer entered address are determined and the geospatial data store is queried with the street segments and one or more area criteria such as, but not limited to zip code.

According to some embodiments, after a location is determined that corresponds to the customer entered address, a location key is generated. The location key can be mapped to a set of one or more location-based services that are available in a location including the customer's address. In one embodiment a services data store stores a plurality of service identifiers in association with location keys, wherein the service identifiers can be accessed using corresponding location keys.

Some embodiments include a customer processing system that includes an address resolution module, a location key generator, and a service availability determination module. The address resolution module resolves civic addresses entered by customers into corresponding locations. The location key generator uses the locations to generate location keys for use in determining services available at the civic address. The service availability determination module uses the location keys to determine available services at the civic addresses associated with the locations of the location keys.

Various embodiments further relate to MSAG address validation and resolution. An MSAG validation process determines whether a customer-entered address corresponds to a valid MSAG address. If the MSAG validation process determines that the customer-entered address does correspond to a valid MSAG address, the MSAG address can be retrieved from a data store of known MSAG addresses. If not, a manual process can be carried out to determine whether the customer-entered address corresponds to a valid MSAG address and what the MSAG address is.

In the MSAG validation and resolution process, MSAG address resolution rules can be used. Examples of rules are, but are not limited to, a city name rule and ‘sounds like’ rule. A ‘sounds like’ rule indexes names by sound to provide alternative names when there are minor errors in the spellings of names.

In one embodiment, a rule set can be generated that facilitates translating civic address components of a physical address into MSAG format when there is not a clear one for one match between the two addresses. Translating the civic address can involve searching for one or more of the state, city, street name, house number, predirectional or postdirectional in an MSAG table. In the case of the house number, the MSAG is searched for a house number range that includes the house number of the civic address. If the search for the city fails (e.g., civic address city not found in MSAG table) a city name rule is used to determine an alternative city name that is consistent with MSAG format. If the search for the street name fails a ‘sounds like’ rule is implemented to determine if any streets of the entered city are phonetically similar, thereby indicating a minor misspelling. One or more alternative spellings can be derived based on phonetic qualities of the entered street name; these one or more alternative spellings are used to search in the MSAG table again.

Prior to describing one or more preferred embodiments of the present invention, definitions of some terms used throughout the description are presented.

### Definitions

The term “variable namespace” refers to a name space in which a name associated with a given address can take on multiple values.

The term “fully qualified namespace” refers to a namespace in which each name associated with a given address can take on only one value.

The term “civic address” refers to an address identified by address data that includes at least one name selected from a variable name space.

The term “customer-entered address” refers to an address identified by address data entered by a customer of a product or service, such as, but not limited to, telecommunication service, and which includes at least one name selected from a variable name space.

The term “customer” refers generally to a subscriber or other customer of a product or service. A customer may or may not be an end-user of the product or service. Examples of subscriber customers are end-user subscribers or enterprise subscribers; other customers include service providers that are customers of wholesale voice network providers. The latter include, by way of example, Internet service providers (ISPs).

The term “location” refers to a geographic location, area or region. A location may be designated using various parameters. For example, in some embodiments a location can be designated by one or more of a rate center, county, zip code, district, region, or one or more latitude/longitude pairs.

A “module” is a self-contained functional component. A module may be implemented in hardware, software, firmware, or any combination thereof.

The terms “connected” or “coupled” and related terms are used in an operational sense and are not limited to a direct connection or coupling.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment.

If the specification states a component or feature “may”, “can”, “could”, or “might” be included or have a characteristic, that particular component or feature is not required to be included or have the characteristic.

The terms “responsive” and “in response to” includes completely or partially responsive.

The term “computer-readable media” is media that is accessible by a computer, and can include, without limitation, computer storage media and communications media. Computer storage media generally refers to any type of computer-readable memory, such as, but not limited to, volatile, non-volatile, removable, or non-removable memory. Communication media refers to a modulated signal carrying computer-readable data, such as, without limitation, program modules, instructions, or data structures.

### Exemplary System

Various embodiments of the present invention are illustrated with respect to providing Voice over Internet Protocol (VoIP) related services. The VoIP context is used merely for illustrative purposes. More generally, embodiments of the present invention can be beneficially employed in any environment where customer-entered addresses need to be resolved to, validated with respect to, and/or translated into another form. The customer-entered addresses may be validated, resolved and/or translated to identify location-based services that may be provided in relation to the customer-entered address.

For example, an embodiment may validate, resolve and/or translate customer-entered addresses in order to generate a map of a location (e.g., area or region) that includes the customer-entered address. As another example, customer-entered address validation, resolution and translation may be beneficially applied in order to facilitate product delivery; for example, to determine which of a number of delivery personnel should deliver the product in the region of the customer-entered address. As yet another example, customer-entered address validation, resolution and translation may be beneficially applied in the context of real estate sales, for example, by realtors. A realtor may determine, for example, school districts, zip codes, or other location-based information, given an address.

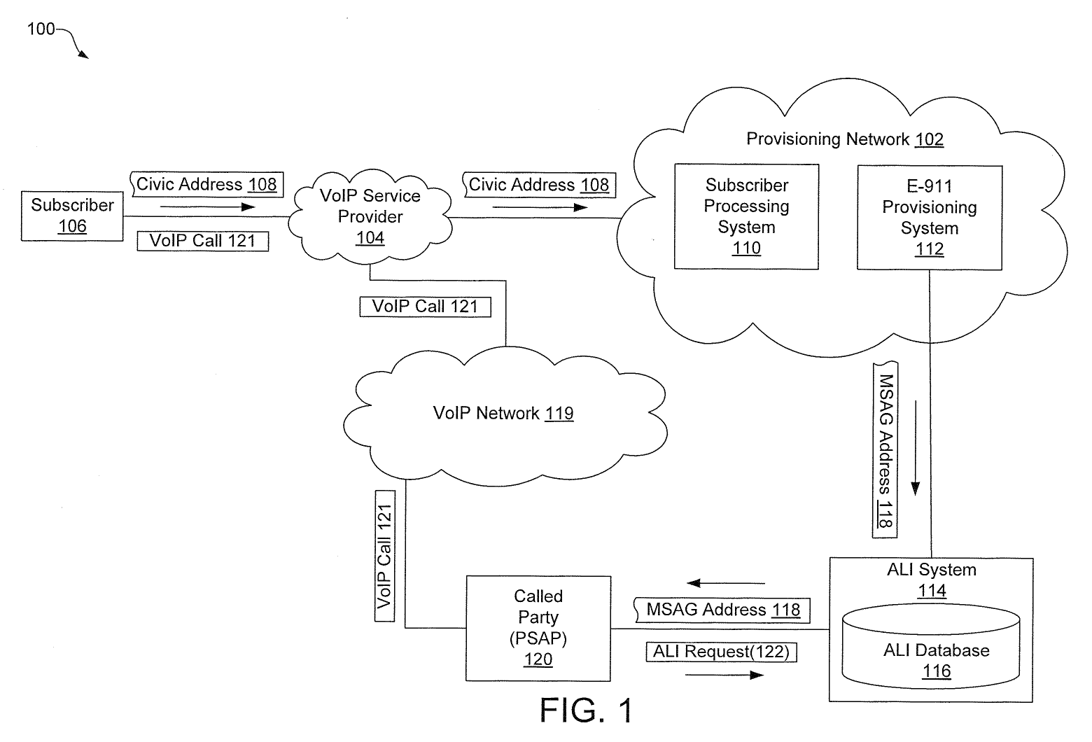

Turning now to FIG. 1, there is illustrated an exemplary operating environment 100, in which customer address resolution can be practiced in accordance with one or more embodiments. A telecommunication service provider, such as a VoIP service provider, provides telecommunication services through one or more VoIP networks 119. A VoIP Network 119 may include one or more networks, such as a wide area network (WAN) (e.g., a backbone network) or local area network (LAN). The VoIP network(s) 119 may be owned and operated by a wholesale network service provider, but this is not necessary. The VoIP network 119 typically provides network connectivity and communications service(s) to other telecommunication service provider networks and/or customers, such as a retail VoIP service provider network 104 and subscribers 106. In the illustrated embodiment, subscribers 106 subscribe to VoIP services offered by the retail VoIP service provider network 104. In some embodiments subscriber may connect directly to the VoIP Network 119.

A retailer operating the VoIP service provider network 104 may be related to the provider of the VoIP network(s) 119 in various ways. Depending on the arrangement, the VoIP service provider network 104 may be a partner, customer, or owner/operator of the VoIP network(s) 119. In some embodiments, the VoIP service provider network 104 may be part of, or include, the VoIP Network 119. One or more of the VoIP service provider network 104 and the VoIP network 119 are in communication with a provisioning network 102. In some embodiments, one or more of the VoIP service provider network 104 and the VoIP network 119 include or are part of the provisioning network 102.

In various embodiments, a retail VoIP service provider and/or wholesale VoIP service provider use addresses of subscribers 106 for numerous purposes, including, but not limited to, subscriber identification, billing, local number portability, taxes, tariffs, services provisioning and E-911 service provisioning. Typically the subscriber's address is received from the subscriber 106 when the subscriber 106 initially subscribes. In the illustrated embodiment, subscriber 106 enters a customer-entered address in the form of a civic address 108, for example, through a computing device (e.g., desktop computer, laptop computer, handheld computer, etc.). For example, the subscriber 106 may navigate, through a browser application, to a web page that provides an interface through which the subscriber 106 enters his/her civic address 108. In the illustrated embodiment, VoIP service provider network 104 receives the civic address 108, and transmits the civic address 108 to the provisioning network 102.

The VoIP service provider network 104 and/or the Provisioning Network 102 typically include systems for provisioning customer-entered addresses into network systems to facilitate providing of location-based services. Provisioning customer-entered addresses typically includes or is preceded by validating and processing customer-entered addresses, such as the civic address 108. For example, in the illustrated embodiment, the provisioning network 102 includes a subscriber processing system 110 and an emergency services provisioning system, such as an E-911 provisioning system 112, for carrying out subscriber address validation and processing. Retail VoIP service provider network 104 may or may not include systems similar to the subscriber processing system 110 and the E-911 provisioning system 112.

Some embodiments of address validation relate to address validation with reference to a standardized address format. A set of reference addresses is provided for comparison to customer-entered addresses and/or for generating addresses in a standardized format. With regard to E-911 services, the reference set of addresses may include a set of MSAG addresses. For example, a standardized address format, the Master Street Addressing Guide (MSAG), is generally used in E-911 provisioning. With regard to E-911 provisioning, the provisioning network 102 is coupled to an Automatic Location Identification (ALI) service 114, which maintains MSAG addresses. The ALI 114 includes an ALI data store 116, which includes numerous subscriber addresses that are used to determine a calling subscriber's location, typically for purposes of routing emergency calls 121 to an appropriate Public Safety Answering Point (PSAP) 120. The ALI data store 116 is typically maintained by Local Exchange Carriers (LECs), and will present the MSAG Address 118 in response to an ALI Request 122. In accordance with embodiments described herein, addresses related to VoIP service subscribers 106 can be provided by the Provisioning Network 102, and more specifically the E-911 provisioning system 112.

For example, the E-911 provisioning system 112 can provide the subscriber's address to the LEC, which provisions the address onto the ALI data store 116. Subscriber addresses in the ALI data store 116 are typically in a common, standard format readily recognizable by PSAP dispatchers and systems so that emergency calls from subscribers 106 are quickly and properly responded to. As mentioned, the standard format of addresses in the ALI data store is the Master Street Address Guide (MSAG). The E-911 provisioning system 112 includes systems and processes for validating the civic address 108 with reference to a set of MSAG addresses, and/or generating an MSAG address 118 based on the civic address 108. The MSAG format is merely one example of a standardized address format that may be used in the address validation process.

Other sets of reference addresses, besides MSAG, may be used for validation. Other address reference sets may be local to one or more communities or they may be relevant to a wide geographical area including numerous communities. For example, a particular county may develop its own “Local Street Address Guide” (LSAG) that has a reference set of addresses in a locally (i.e., county wide) standard form. Validation of customer-entered addresses could be performed with reference to such an LSAG or other reference set. Validation of customer-entered addresses could be performed with reference to one or more address reference sets. The address reference set used for validation may be selected based on some criteria, such as the service or product being provisioned and/or the locality of the address. For example, a given customer-entered address may be validated with reference to one address reference set for one service or locality and validated with reference to another address reference set for another service or locality.

With further regard to the customer-entered civic address 108, civic addresses 108 include names selected from a variable namespace. A given civic address 108 may vary in format and naming convention from one subscriber to another and may include errors, such that the erroneous address data may not correspond to an actual address. The variation of the civic address 108 or existence of errors can depend on numerous factors. The customer may simply make a typographical error. The format of the civic address 108 could depend in part, for example, on the interface that the subscriber 106 uses to enter the civic address 108. One function of the subscriber provisioning system 110 is to accept the civic address 108 if the address 108 can be determined to correspond to, or resolved to, an actual address; otherwise the civic address 108 will be rejected as invalid or un-resolvable.

In addition, the naming convention of the civic address 108 typically depends on subscriber's understanding of preferred names in their localities. A street that one subscriber prefers to call Elm Street, another subscriber may prefer to call Highway 42, and both names may correctly refer to the same street. As another example, one subscriber may use a predirectional (e.g., North) before the house number, while another subscriber does not use the predirectional. However, for some location-based services, such as E-911, naming convention and format must be consistent; i.e., there cannot be two names for the same address. Subscriber processing system 110 and E-911 provisioning system 112 include modules and processes for resolving a customer-entered address 108 to a consistent format and naming convention to support location-based service provisioning, including telecommunication service provisioning and E-911 service provisioning.

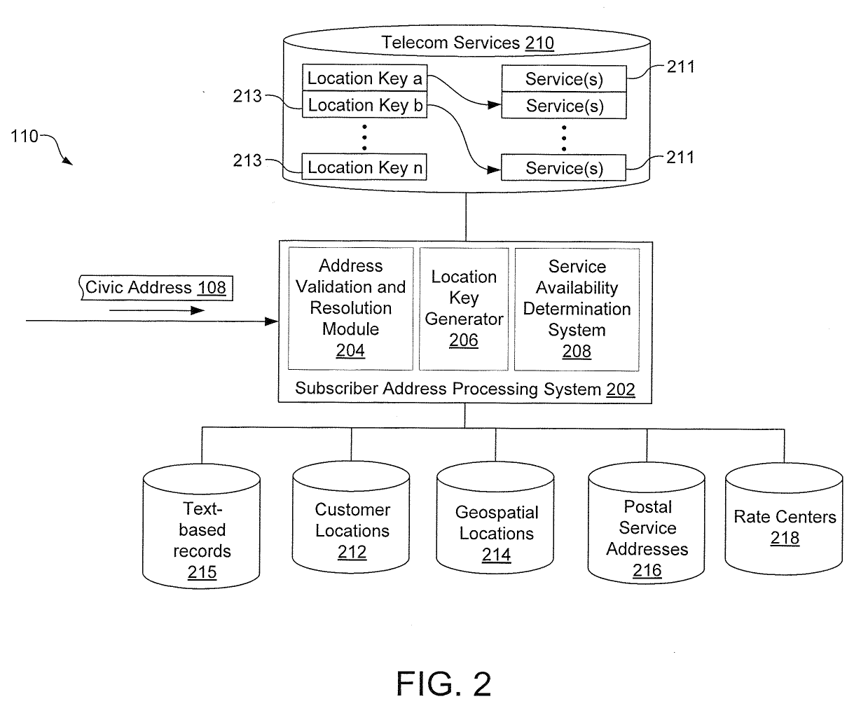

FIG. 2 illustrates an embodiment of a subscriber processing system 110 for processing subscriber information, including customer-entered addresses 108, to support telecommunication services provisioning. The subscriber processing system 110 includes a subscriber address processing system 202 that determines telecommunication services, if any, that are available at the addresses 108 entered by customers (e.g., retail VoIP service providers or subscribers). The subscriber address processing system 202 includes an address validation and resolution module 204, a location key generator 206 and a service availability determination module 208.

In accordance with the illustrated embodiment, the address validation and resolution module 204 is operable to validate the customer-entered address 108 and resolve the address 108 to a form that can be used to determine service(s) available at the address 108. In one embodiment of the address validation and resolution module 204 a location is determined that is based on the customer-entered address. The location key generator 206 forms a location key from the location determined by the address validation and resolution module 204. The location key is in a format that enables identification of location-based services (e.g., telecommunications services) that are available at the location, and hence, available at the customer-entered address 108. The services availability determination module 208 uses the location key to search a telecommunication services data store 210 that stores one or more location-based service names or identifiers 211 that indicate services that are available at the various locations specified by corresponding location keys 213.

The address validation and resolution module 204 interacts with one or more sets of data to validate and resolve the customer-entered address 108 to a location. In one embodiment, the location is in a form that corresponds to one or more location-based services. For example, in one embodiment, the location is a “Rate Center”. A Rate Center corresponds to a definition of local Telephone services, 911 Coverage, a responsible 911 agency associated with the location, and a routing instruction, which represents the method to deliver the call to the appropriate agencies. The translation of the address into a location can be performed via a technical means, for example using Latitude/Longitude (Lat, Lon), but this is not required.

A customer locations data store 212 includes one or more subscriber addresses associated with corresponding locations. In one embodiment, as subscriber addresses and their corresponding locations are learned (i.e., are determined) over time, they are stored in the customer locations data store 212, where they can be used later. For example, if a first subscriber moves into a home at an address that is validated and resolved to a location, and a second subscriber later moves into the home (at the same address), the address can be retrieved from the customer locations data store 212, and is presumed to be valid based on prior validation.

A geospatial data store 214 supplies locations in response to queries. A query to the geospatial data store 214 typically specifies one or more area criteria, such as, but not limited to address, zip code or county. In some embodiments, the geospatial data store 214 is owned and managed by a commercial entity that provides geospatial data services. Examples of such entities include TeleAtlas™ and Neustar™. In one embodiment, the address validation and resolution module 204 queries the geospatial data store 214 if the customer locations data store 212 does not have a location associated with the customer-entered address 108. Geospatial data store 214 uses Geographic Information Systems (GIS). Customer Locations in the context of Telephone companies use MSAG Database. The data transacted is different for the two databases and hence they have different data points. In one embodiment, the customer locations data store 212 stores and/or provides locations in a representation similar to that of the geospatial data store 214.

A postal service data store 216 stores postal addresses and can be queried as to whether a given address is recognized as a valid postal address. In one embodiment, if the geospatial data store 214 does not return a location in response to a query with the customer-entered address 108, the postal service data store 216 is queried with the customer-entered address 108.

If the postal service data store 216 indicates that a customer-entered address 108 is a valid postal address, but the geospatial data store 214 and the customer locations data store 212 do not have location data corresponding to the customer-entered address 108, then the address validation and resolution module 204 is operable to perform a location estimation process, which is described in more detail below. Briefly, the location estimation process involves querying the geospatial data store 214 with street segments bounding the given house (or building, office, apartment, suite) number and one or more area criterion related to an area that is near or around the customer-entered address 108. Location estimation may involve interpolation, whereby the location of the customer-entered address 108 is interpolated between two ranges of numerical street addresses. In some embodiments, a confidence factor is applied to the estimation. The confidence factor may be viewed as a “judgment” value that can be adjusted to achieve a desired level of accuracy. The confidence factor designates an accuracy range. A wider accuracy range generally indicates that the relationship of address to location is less important, while a tighter (i.e., narrower) accuracy range indicates that the relationship is more important. Based on the confidence (“judgment”) factor a single location and associated location-based service will be determined given multiple options; or, if a location cannot be determined to the level of accuracy dictated by the confidence level, the address will ultimately be rejected.

In some embodiments, if the customer-entered address 108 cannot be validated or resolved using the geospatial data store 214, postal service data store 216 or customer locations data store 212, a text-based valuation process is performed. The text-based valuation process utilizes a text based source 215 of “Approved” records. If the customer-entered address 108 is found in the text-based source 215, the address 108 is considered valid. In one embodiment the text-based source 215 includes 1 to N different text based lists. The lists are updated and edited over time, thereby gaining accuracy over time. In this embodiment, the text-based source 215 is a dynamic knowledge base of text-based address information.

In accordance with at least one embodiment, if the customer locations data store 212, the geospatial data store 214 and the text-based source 215 do not have record of the civic address 108, and the postal service data store 216 do not recognize (i.e., do not have data corresponding to) the customer-entered address 108, then the customer-entered address 108 is considered invalid. In such a situation, the civic address 108 would not be accepted for provisioning of location- based services.

If the customer-entered address 108 is determined to be valid and a location corresponding to the address 108 is generated, the location key generator 206 reads the generated location and forms a location key. In one embodiment, the location key is a combination of a rate center and one or more other area criteria. Rate centers are stored in and can be retrieved from a rate centers data store 218 based on a given location. In general, a rate center specifies a local exchange area and can include NPA-NPX combinations and their associated LATA, CLLI code(s), Operating Company Numbers (OCNs), areas served, carriers, and other data. One or more of the portions of the rate center data can be included in the location key. The location key generator 206 combines selected rate center data with one or more other area criteria, such as county or zip code.

The services availability determination module 208 uses location keys from the location key generator 206 to search the telecommunication services data store 210 to identify services that are available at the location associated with the customer-entered address 108. In this embodiment, there is a 1 to 1 mapping from location keys 213 to location-based service sets 211.

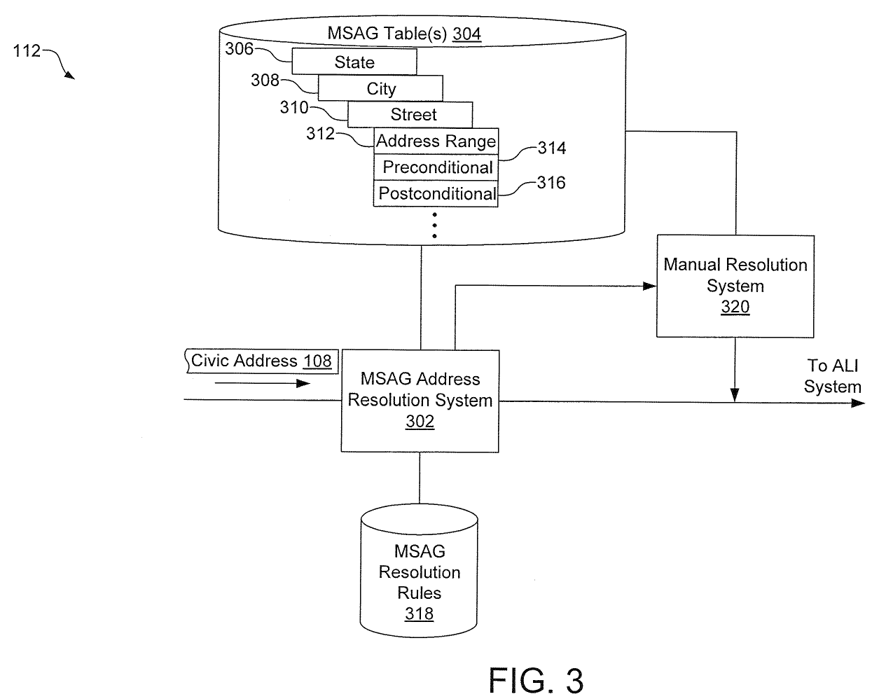

FIG. 3 illustrates and embodiment of the E-911 provisioning system 112. This embodiment of the E-911 provisioning system includes a Master Street Address Guide (MSAG) address resolution module 302. Generally, the MSAG address resolution module 302 includes processing and logic that is operable to resolve one or more civic address names from a variable name space to corresponding name(s) in a fully qualified name space. This MSAG name space is strictly for the E-911 Service and hence a 1 to 1 mapping from address to E-911 services.

One embodiment of the fully qualified namespace is one or more MSAG table(s) 304. An MSAG table 304 includes a set of addresses in association with Emergency Service Numbers (ESNs) identifying Emergency Service Zones (ESZs). Each address is a logical grouping of address components. For example, an MSAG table typically includes one or more state names 306, one or more city names 308 associated with each state name 306, one or more street names 310 associated with each city name 308, one or more address ranges 312 associated with each street name 310, and optionally a predirectional (prefix) 314 and/or a postdirectional (suffix) 316 associated with each address range 312. Data from an exemplary portion of an MSAG table is shown below in Table 1:

TABLE 1
Exemplary MSAG Data
California

| Street | Range | | City | ESN | |
|---|---|---|---|---|---|
| Vista Grande | 700 | 1399 | MLBR | CAB00317 | 02142006 |
| Willow Av | 0 | 299 | MLBR | CAB00317 | 02142006 |
| 10^{th} Av | 600 | 699 | MNLO PK | CAB00325 | 02142006 |
| 10^{th} Av | 700 | 899 | MNLO PK | CAB00329 | 02142006 |

In Table 1, MSAG data for two California cities are shown. The city names are given in the third column from the left. The name “MLBR” stands for Millbrae and the name “MNLO PK” stands for Menlo Park. Street names are given in the first column on the left. In the exemplary data, Vista Grande and Willow Av are two streets in MLBR, and 10^{th} Av is a street in Menlo Park. Street address ranges are given in the second column from the left. For example, the street Vista Grande has a range from 700 to 1399; 10^{th} Av in Menlo Park has a range from 600 to 699 and another range from 700 to 899. ESNs associated with each combination of state, street, range and city are shown in the fourth column from the left. Predirectionals and postdirectionals are not shown in Table 1, but they could be included. An example of a predirectional is ‘N’, standing for North. An example of a postdirectional is ‘SW’, standing for Southwest.

As discussed above, the civic address is the customer-entered format. The MSAG resolution module 302 generally attempts to map the civic address to an address in the MSAG Format, which adheres to the rules set by the ALI Database. In one embodiment, the civic address is mapped to the MSAG Format by a set of rule sets that are used to transform the customer-entered address to MSAG format.

In the illustrated embodiment, the MSAG address resolution module 302 searches the MSAG table(s) for an address entry or entries that correspond to the received civic address 108. If corresponding address entries cannot be found, the MSAG address resolution module 302 uses MSAG resolution rules 318 to derive alternative spellings for names that cannot be found. The MSAG resolution rules 318 can include rules such as, but not limited to, city name rules, street name rules and phonetic (‘sounds like’) rules.

In one embodiment a city name rule maps possible spelling (or misspellings) of city names to city name spellings that are used in the MSAG table(s). For example, one mapping may associate “Minlo Park” with “MNLO PK”. Street name rules map possible spellings (or misspellings) of street names to street name spellings that are used in the MSAG table(s). For example, a street name rule may map “Willow Street” to “Willow St”. Phonetic rules provide mappings between street names and other possible street names that sound like the received street names. Localized names may be used to map street names for example University Boulevard, El Paso, Tex., is mapped to Univ Blvd, El Paso Tex. As other examples, 100 Main Street may be mapped to N. Main St; Peachtree St, Smyrna, Ga. may be mapped to Peachtree St, Roswell, Ga.; and 200 Bush Av may be mapped to 100 Bush St etc.

Using the alternative spellings provided by the MSAG resolution rules, the MSAG address resolution module 302 searches in the MSAG table(s) one or more times. If the MSAG resolution module 302 still cannot resolve the civic address to an MSAG address using MSAG resolution rules 318, a manual MSAG resolution system 320 is notified. In the manual MSAG resolution system 320 humans map the received civic address 108 to a proper MSAG address. The resulting MSAG address, ESN and telephone number are sent to the administrator of the ALI data store for inclusion therein.

### Exemplary Operations

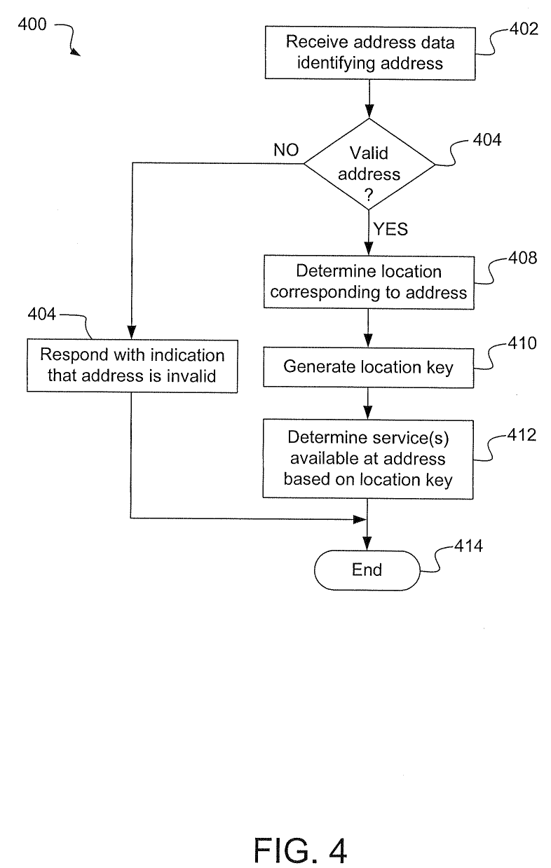

FIG. 4 is a flowchart illustrating an address validation and service determination algorithm 400. The algorithm 400 may be carried out by the subscriber address processing system 202 (FIG. 2). The algorithm 400 is typically performed when a new subscriber subscribes to telecommunication service. The new subscriber or telecommunication service company personnel may enter address data through a terminal or computer system.

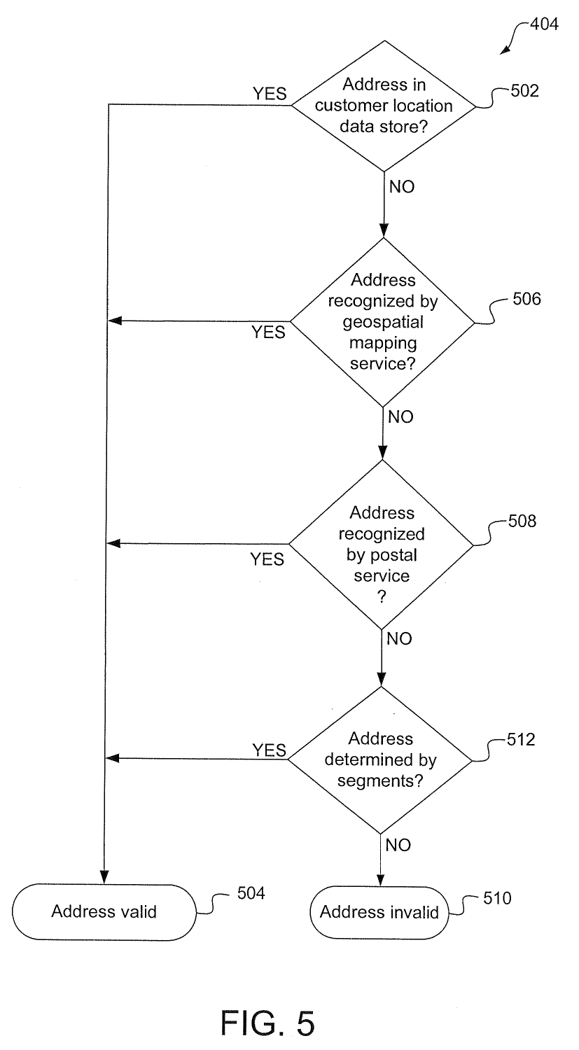

A receiving operation 402 receives the address data identifying the subscriber's address. The address is typically composed of a number of parts, such as a state name, city name, street name, home number (or building number, office number, etc.), and perhaps a predirectional and/or postdirectional. A validating operation 404 determines whether the received address is a valid address. In one embodiment the validating operation 404 determines if the received address corresponds to an actual address as indicated by a number of data sets that store recognized or confirmed actual addresses. An embodiment of the validating operation 404 is shown in FIG. 5, which is described in detail further below.

If the validating operation 404 determines that the received address data does not correspond to an actual address, the algorithm 400 branches “NO” to a responding operation 406, which responds to the received address data with an indication that the address data is invalid.

On the other hand, if the validating operation 404 determines that the received address does correspond to an actual address, the address data is accepted, meaning that the identified address is deemed to represent an actual address. The algorithm 400 then branches “YES” to a determining operation 408. The determining operation 408 determines a location associated with the identified address. In one embodiment, the location that is determined is a Rate Center that corresponds to the customer-entered address. In one embodiment, the determining operation 408 retrieves the location from a customer locations database that stores multiple addresses in association with corresponding locations. In another embodiment, the determining operation determines the location by querying a geospatial data service that provides location data based on a given address.

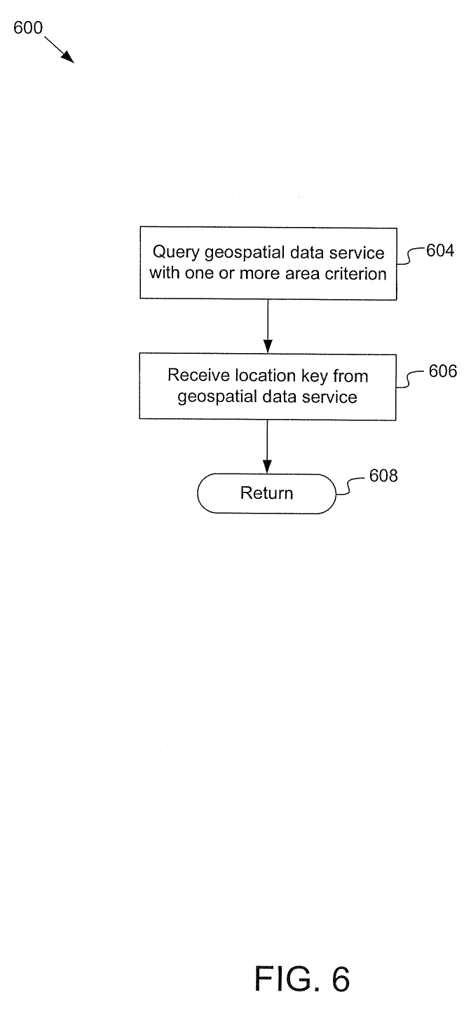

In yet another embodiment, determining operation 408 employs a location estimation process. In a location estimation process, a location is derived based on determined street segments on either side of the house number on the street in the received address data. An embodiment of a location estimation process is shown in FIG. 6 and described further below in detail.

In a generating operation 410, a location key is generated. The location key is configured for looking up a set of services in a data store that stores service identifiers identifying services available at the location indicated by the location key. In one embodiment of the generating operation 410, the location key is generated by combining rate center data with one or more area criteria. The one or more other area criteria could be a zip code, a county name, a district name, a LATA, or others.

Another determining operation 412 determines one or more telecommunication services that are available at the location of the subscriber's address. In one embodiment, the determining operation 412 indexes into the services data store with the location key. Services identified by the location key can then be provisioned to the subscriber's address. The address validation and services determination algorithm 400 ends at ending operation 414.

FIG. 5 is a flowchart illustrating an embodiment of the address validating operation 404 for validating the address identified by address data received from a customer. In a querying operation 502, a customer locations data store is queried with the received address. The address is searched for in the customer locations data store. In one embodiment, if the address is found, an associated location from the customer locations data store is returned in the indicating operation 504.

If the address is not found in the customer locations data store, the validating algorithm 404 branches “NO” to another querying operation 506. The querying operation 506 queries a geospatial data store with the received address. The geospatial data store searches for the address in geospatial records. If the address is found in the geospatial data store the validating algorithm 404 branches “YES” to the address valid indicating operation 504.

If the address is not found in the geospatial data store, the validating algorithm 404 branches “NO” to another querying operation 508. The querying operation 508 queries a postal service data store with the address to determine if the address is recognized as a valid address by the postal service.

If the address is found in the postal service data store, the algorithm 404 branches “YES” to the address valid indicating operation 504. Unlike the customer locations data store and the geospatial data store, the postal service data store does not return a location key with the address if the address is valid. In the event the postal service determines the address is valid when neither the customer locations data store nor the geospatial data store have record of the address, another process is performed to determine the location key of the address. One embodiment, the postal ZIP code is used within the Geospatial data store to build the location key associated with the address. In other embodiments, the county, Zip, Zip+5 may be used to determine the appropriate Location Key. Typically, with determined address embodiments, an associated judgment factor will be used to determine if the address will be accepted. In one example, if the location key is 75% in union with the required service, the address will be accepted.

If the address is not found in the postal service data store, the validating algorithm 404 branches “NO” to an estimation operation 512. The estimation operation 512 attempts to estimate or predict the location of the address based on a confidence factor. An embodiment of the estimating operation is shown in FIG. 6 and described below. If the estimation operation 512 determines a location based on the confidence factor, the determined location is returned in the indicating operation 504; otherwise an address invalid indicating operation 510 returns an indication that that customer-entered address is invalid and will not be accepted. In one embodiment, if the address is not determined to be valid, the subscriber or customer may be prompted to retry entering the address.

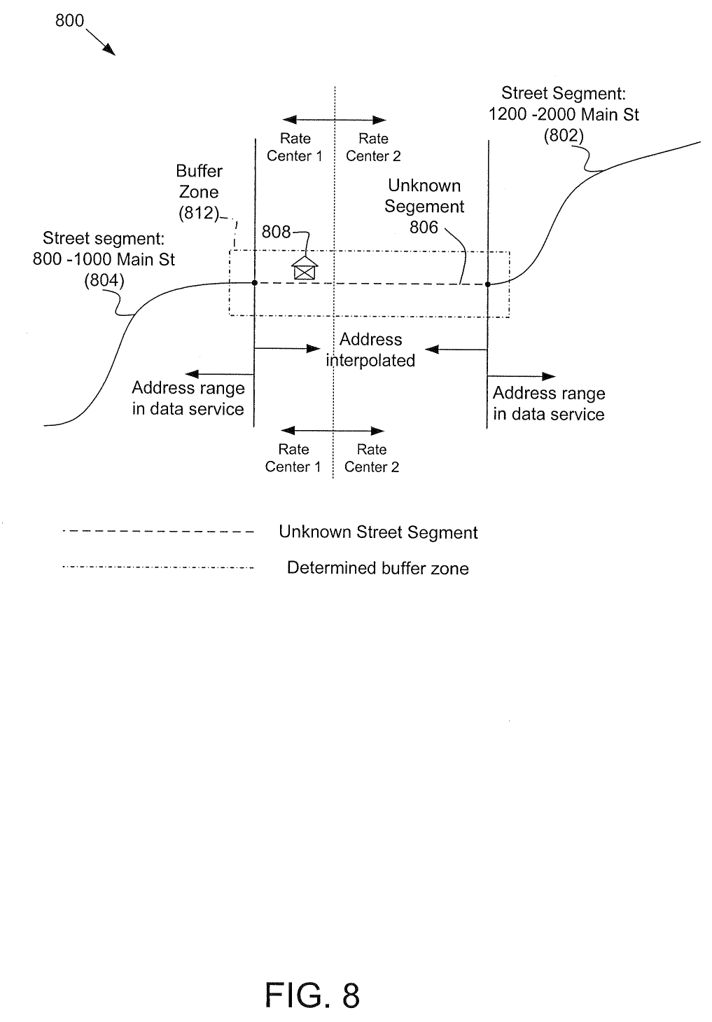

FIG. 6 is a flowchart illustrating a location estimation algorithm 512 for determining a location of an address that is assumed to be valid but for which geospatial records do not include and cannot provide a location. Location estimation algorithm 512 attempts to locate the address between two segments of the street of the address. If two street segments can be located that bound the address, it is presumed that the address is located between the two street segments and the location can be estimated based on the locations of the two street segments. FIG. 6 is described with reference to FIG. 8.

FIG. 8 illustrates a portion of a street 800, which has a first segment 802 and a second segment 804 that bound a third, unknown segment 806. The segments have associated street address number ranges: 800-1000 and 1200-2000 respectively. It is assumed that number ranges of the first segment 802 and the second address segment 804 are found in a data service, such as a geospatial data service. The third segment 806 spans an address range that is not found directly in the data service. The algorithm shown in FIG. 6 uses data that is known about the first segment 802 and the second segment 804 to estimate a location associated with the address which is assumed to be in the third segment 806.

In the particular embodiment of FIG. 8 two locations, such as rate center 1 and rate center 2, are shown that can be mapped to location-based services. The locations could be in another form, such as county. In this particular illustrative scenario, the civic address 808 entered by the customer is in rate center 1. In one embodiment of the estimation operation 512, interpolation is used to determine which rate center the civic address is located in.

In one embodiment, a querying operation 604 bounds the unknown segment 806 and contiguous ends of each of the two segments (e.g., segment 802 and segment 804) in a ‘buffer zone’ 812, indicated by a buffer factor, and then checks whether a rate center (or county or other location designation) of the address 808 can be determined with a specified level of confidence (indicated by a confidence factor). If there is high confidence that the address's rate center can be determined, it will pass, if low, it will not. The buffer and confidence factors are adjustable to determine a location with more or less accuracy. For example, the buffer zone 812 can be widened if the unknown segment 806 is assumed to be curved, or narrowed if the unknown segment 806 is assumed to be straighter.

In a receiving operation 606, one or more locations are received from the geospatial data store in response to the query or queries that are issued in the querying operation 604. A returning operation 608 returns the location key generated in the previous steps.

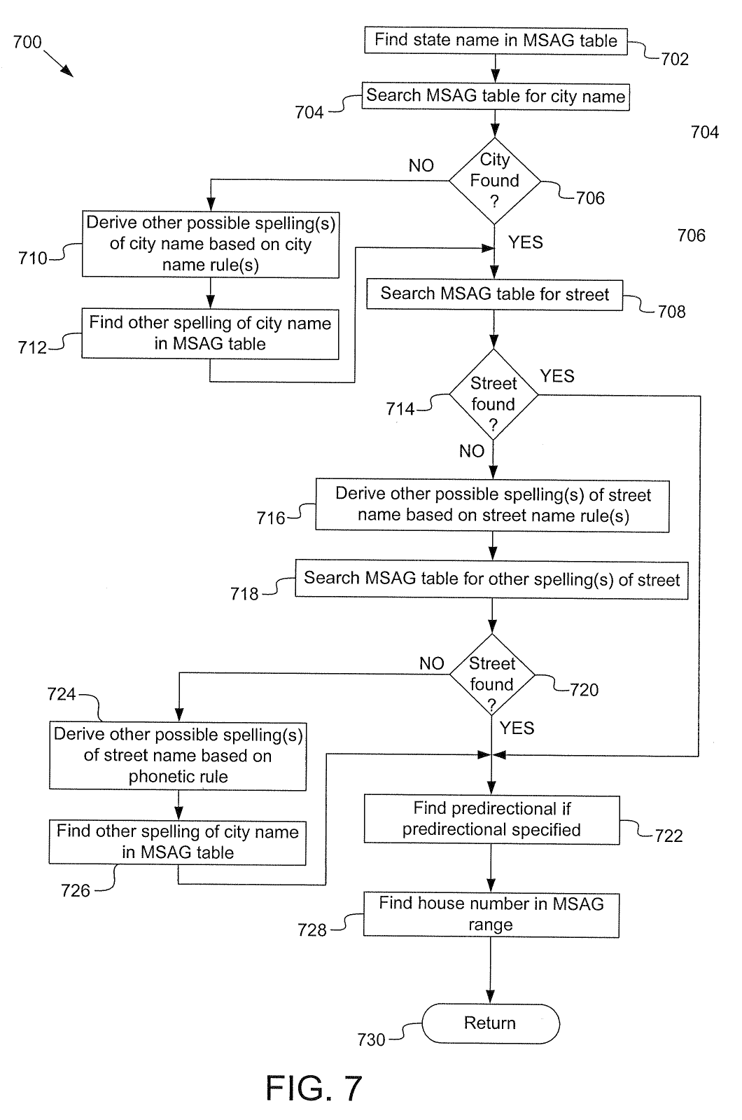

FIG. 7 is a flowchart illustrating an MSAG address resolution algorithm 700 that may be performed by the MSAG address resolution system 302 of FIG. 3. It is assumed that a civic address has been received that has a number of components, such as state name, city name, street name, house number, a predirectional and/or a postdirectional. Generally, at a minimum, the civic address needs to include a state name, city name, street name and house number in order for the address to resolved. Predirectional and postdirectional are typically optional, but may be required, for example, if the street has direction parameters and multiple of the same house numbers exist on the street (e.g., N. 320 Main St; S. 320 Main St). It is assumed that the received civic address includes the minimum components and they correspond to components in the MSAG table(s)

In a finding operation 702, the MSAG table(s) is searched for the state name specified in the civic address. After the state name is found, a searching operation 704 searches the MSAG table(s) for the city name specified in the civic address. A query operation 706 queries whether the city name was found. If the city name was found, the algorithm 700 branches “YES” to another searching operation 708 that searches in the MSAG table(s) for the street name specified in the civic address.

If, on the other hand, the query operation 706 determines that the city name was not found, the algorithm 700 branches “NO” to a deriving operation 710. The deriving operation 710 derives one or more alternative spellings of the city name based on city name rules. In one embodiment, city name rules associate a set of possible city names to alternative spellings used in the MSAG namespace. Using the alternative spelling(s), a finding operation 712 searches in the MSAG table for the alternatively spelled city name. After the city name is found, the algorithm 700 branches to the searching operation 708.

After searching operation 708 searches the MSAG table for the street name specified in the civic address, a query operation 714 queries whether the street name was found in the MSAG table(s). If the street name was found in the MSAG table(s), the algorithm 700 branches “YES” to a finding operation 722 discussed further below.

If the query operation 714 determines that the street name was not found during the searching operation 708, the algorithm 700 branches “NO” to another deriving operation 716. The deriving operation 716 derives one or more alternative spellings of the street name based on street name rules. Another searching operation 718 searches for the one or more alternative spellings of the street name in the MSAG table(s).

Another query operation 720 determines whether the street name was found. If the street name was found, the algorithm 700 branches “YES” to the finding operation 722. If the street name was not found during the searching operation 718, the algorithm 700 branches “NO” to another deriving operation 724. The deriving operation 724 derives one or more other possible spellings of the street name based on phonetic rules that associate street name spellings to other spellings that are phonetically similar. A finding operation 726 finds one of the alternative spellings of the street name in the MSAG table(s).

Finding operation 722 is optional depending on whether a predirectional is specified in the civic address. If a predirectional is specified, the finding operation 722 finds the predirectional in the MSAG table(s). In another finding operation 728 The MSAG table(s) is then searched for the house number specified in the civic address. When the house number is found, all the components of the civic address will be resolved to an MSAG address, which is the logical combination of the MSAG entries that were found. A returning operation 730 returns the determined MSAG address.

### Exemplary Computing Device

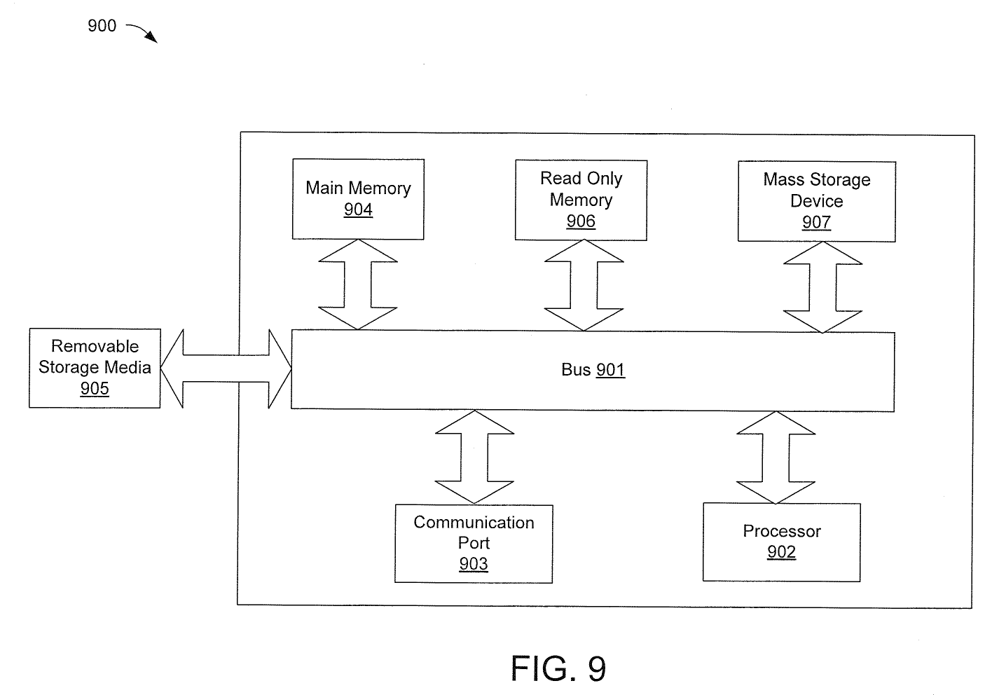

FIG. 9 is a schematic diagram of a computing device 900 upon which embodiments of the present invention may be implemented and carried out. As discussed herein, embodiments of the present invention include various steps. A variety of these steps may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware.

According to the present example, the computing device 900 includes a bus 901, at least one processor 902, at least one communication port 903, a main memory 904, a removable storage media 905, a read only memory 906, and a mass storage 907. Processor(s) 902 can be any know processor, such as, but not limited to, an Intel® Itanium® or Itanium 2® processor(s), AMD® Opteron® or Athlon MP® processor(s), or Motorola® lines of processors. Communication port(s) 903 can be any of an RS-232 port for use with a modem based dialup connection, a 10/100 Ethernet port, a Gigabit port using copper or fiber, or a USB port. Communication port(s) 903 may be chosen depending on a network such a Local Area Network (LAN), Wide Area Network (WAN), or any network to which the computing device 900 connects. The computing device 900 may be in communication with peripheral devices (not shown) such as, but not limited to, printers, speakers, cameras, microphones, or scanners.

Main memory 904 can be Random Access Memory (RAM), or any other dynamic storage device(s) commonly known in the art. Read only memory 906 can be any static storage device(s) such as Programmable Read Only Memory (PROM) chips for storing static information such as instructions for processor 902. Mass storage 907 can be used to store information and instructions. For example, hard disks such as the Adaptec® family of SCSI drives, an optical disc, an array of disks such as RAID, such as the Adaptec family of RAID drives, or any other mass storage devices may be used.

Bus 901 communicatively couples processor(s) 902 with the other memory, storage and communication blocks. Bus 901 can be a PCI/PCI-X, SCSI, or USB based system bus (or other) depending on the storage devices used. Removable storage media 905 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM).

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

What is claimed is:

1. A computer-implemented method for providing a location-based service, the method comprising:
receiving address data identifying a civic address;
determining a location corresponding to the identified civic address based on the address data; and
determining whether one or more services are available at the identified civic address based on the determined location.

2. The computer-implemented method as recited in claim 1, wherein the received address data comprises a street name and a street number, and wherein determining a location corresponding to the identified address comprises determining a first street segment of the named street on one side of the identified address and a second street segment of the named street on another side of the received address.

3. The computer-implemented method as recited in claim 2 wherein a street number of the first street segment, the street number of the identified address and a street number of the second street segment identify contiguous sections of the named street.

4. The computer-implemented method as recited in claim 1 further comprising generating a location key based on the location.

5. The computer-implemented method as recited in claim 4 wherein generating the location key comprises combining a rate center associated with the identified address and one or more area criteria associated with the identified address.

6. The computer-implemented method as recited in claim 4, further comprising mapping the location key to a set of one or more location-based service identifiers.

7. The computer-implemented method as recited in claim 1, wherein the received address data includes at least one name chosen from a variable name space, the computer-implemented method further comprising translating the at least one name chosen from the variable name space to a corresponding name in a fully qualified name space.

8. The computer-implemented method as recited in claim 7, wherein the fully qualified name space comprises at least a subset of a Master Street Address Guide (MSAG).

9. The computer-implemented method claim 1, further comprising validating the received address data to determine if the identified address is an actual address.

10. The computer-implemented method as recited in claim 9, wherein validating the received address data comprises:
searching a customer location data store for the identified address, the customer location data store storing data that associates previously validated addresses with locations;
if the identified address is not found in the customer location data store, querying a geospatial data store for a location corresponding to the identified address;
if the geospatial mapping service does not supply a location corresponding to the identified address, querying a postal service data store to indicate whether the identified address is an actual address; and
if the postal service data store does not indicate whether the identified address is an actual address, determining a probability that the identified address is an actual address and accepting the identified address based on a confidence factor.

11. The computer-implemented method as recited in claim 10, wherein determining a location corresponding to the identified address further comprises:
if the postal service indicates that the identified address is an actual address, querying the geospatial mapping service with one or more area criterion to obtain a determined location and accepting the address based on the confidence factors.

12. A system for identifying one or more location-based services available at an address, the system comprising:
an address validation and resolution module operable to determine a location corresponding to a civic address;
a location key generator operable to generate a location key adapted to index a set of location-based services identifiers; and
an available services determination module operable to use the location key to index the set of location-based services identifiers to determine location-based services available at the civic address.

13. The system as recited in claim 12, wherein the address validation and resolution module is further operable to validate the civic address by querying one or more customer supplied data stores, a geospatial data store and a postal service.

14. The system as recited in claim 12, wherein the location key generator generates the location key by combining rate center data with one or more area criteria.

15. The system as recited in claim 12, further comprising a Master Street Address Guide (MSAG) address resolution module operable to resolve the civic address to an MSAG address.

16. The system as recited in claim 15, further comprising an MSAG resolution rule set comprising rules for deriving alternative spellings of names in the civic address.

17. The system as recited in claim 16, wherein the MSAG resolution rule set comprises one or more of city name rules, street name rules, and phonetic rules.

18. A computer-readable medium having computer-executable instructions that cause a computer to carry out a process comprising:
receiving a civic address including a plurality of names selected from a variable namespace;
searching an address reference set for a name included in the civic address;
if the name is not found in the address reference set, deriving an alternative spelling of the name; and
searching the address reference set with the alternative spelling of the name.

19. The computer-readable medium as recited in claim 18 wherein deriving an alternative spelling comprises phonetically mapping the name to an alternative spelling of the name.

20. The computer-readable medium as recited in claim 18 wherein deriving an alternative spelling comprises mapping the name to a spelling that is used in a namespace of the address reference set.
